(19) United States
(12) Patent Application Publication
(10) Pub. No.: US 2020/0149463 A1
(43) Pub. Date: May 14, 2020

(54) COOLANT DE-AERATION RESERVOIR

(71) Applicant: Calsonic Kansei North America, Inc., Farmington Hills, MI (US)

(72) Inventors: Bryan Trythall, Carleton, MI (US); Dale S. Seyler, West Bloomfield, MI (US)

(21) Appl. No.: 16/185,949

(22) Filed: Nov. 9, 2018

(51) Int. Cl. F01P 11/02; F01P 11/06; B01D 19/00; B01D 36/00; B01D 35/30

(52) U.S. Cl. CPC F01P 11/028; F01P 11/06; B01D 19/0073; B01D 2201/301; B01D 35/30; F01P 2011/061; B01D 36/001

(57) ABSTRACT

A de-aeration reservoir for a vehicle includes an inlet and an outlet., and a receptacle configured to receive a filter therein, the receptacle downstream from the inlet. The de-aeration reservoir further includes a plurality of chambers formed in the reservoir downstream from the receptacle, and a de-aeration opening formed in the receptacle and fluidly connecting the receptacle to an inlet chamber of the plurality of chambers.

### BACKGROUND

The present application relates generally to the field of de-aeration reservoirs for coolant and more specifically to reservoirs in a vehicle.

In a vehicle, coolant (e,g., water, oil, etc.) passes through various systems (e.g., HVAC, battery cooling, engine cooling, etc.). As the coolant flows through these systems, it passes through pumps, nozzles, radiators, and other components that affect the flow. Each of these components may cause cavitation in the fluid when the laminar flow of the fluid is disrupted at an edge or corner, generating turbulence, which in turn causes small air pockets to form in the coolant. Over time, the presence of the air pockets can damage the various components when the air pockets collapse, which may generate small shockwaves that are received by the corresponding device. Further, the presence of the air pockets within the coolant may disrupt the efficient transfer of heat to and from the coolant,

Vehicles may de-aerate the coolant in the various systems by slowing down the flow in a reservoir, allowing it to rest so that the air may dissipate from the coolant. However, conventional de-aeration systems provide separate fluid lines that divide the coolant into two separate flow paths—a first path for de-aeration and a second path that bypasses the de-aeration system. In other words, only a portion of the coolant is being de-aerated in such systems at the same time. These systems also require special care when replacing filters in order to avoid coolant loss and maintain proper coolant levels in the systems.

It would be advantageous to provide a de-aeration reservoir that internally separates and filters coolant for use in a vehicle. This and other advantages will be apparent to those reviewing the present application.

### SUMMARY

One embodiment relates to a de-aeration reservoir for a vehicle, including an inlet and an outlet, and a receptacle configured to receive a filter therein, the receptacle located downstream from the inlet. The de-aeration reservoir further includes a plurality of chambers in the reservoir located downstream from the receptacle, and a de-aeration opening formed in the receptacle and fluidly connecting the receptacle to an inlet chamber of the plurality of chambers.

Another embodiment relates to a method of de-aerating coolant in a vehicle, including receiving coolant at an inlet of a reservoir, the reservoir defining a receptacle and a filter disposed in the receptacle, and passing the coolant downstream from the inlet to the filter.

### BRIEF DESCRIPTION OF THE DRAWINGS

FIG. 1 is a schematic view of a conventional de-aeration system.

FIG. 2 is an example of a reservoir used in the conventional de-aeration system of FIG. 1.

FIG. 3 is a schematic view of a de-aeration system according to an exemplary embodiment.

FIG. 4 is a perspective view of an exemplary embodiment of a de-aeration reservoir used in the de-aeration system of FIG. 3.

FIG. 5 is a cross-sectional view of the reservoir of FIG. 4, taken across line 5-5, showing how an oil filter is installed in the reservoir.

FIG. 6 is a cross-sectional view of the reservoir of FIG. 5, taken across line 6-6, showing the flow of fluid in the reservoir.

### DETAILED DESCRIPTION

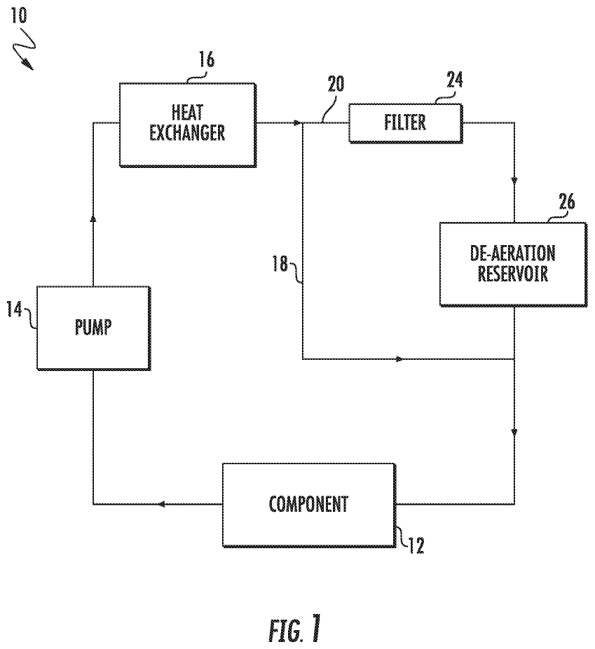

Referring to FIG. 1, a conventional de-aeration cycle 10 for a vehicle is shown. The vehicle includes a component 12 in a vehicle system, such as an HVAC system, a battery cooling system, or an engine cooling system. Heat is transferred from the component 12 to the coolant, such that the temperature in the coolant increases while the temperature in the component 12 decreases. Heated coolant flows from the component 12 to a pump 14, which then outputs the coolant to a heat exchanger 16, where heat is transferred out of the coolant, dropping the temperature of the coolant before being eventually reintroduced to the component 12.

The coolant then flows from the heat exchanger 16 and is separated into a bypass stream that flows through a bypass line 18 and a de-aeration stream that flows through a separate de-aeration line 20. The proportion of coolant passing through each of the bypass and de-aeration lines 18, 20 may be controlled by the cross-sectional areas of the bypass and de-aeration lines 18, 20. For example, if the ratio of cross-sectional areas of the bypass line 18 to the de-aeration line 20 is 4:1, the 80% of the coolant passes through the bypass line 18 and the remaining 20% of the coolant passes through the de-aeration line 20. In this configuration, it can be difficult to provide the exact desired ratio of coolant to each of the bypass line 18 and the de-aeration line 20, because the cross-sectional areas of each line 18, 20 may depend on a limited selection of standardized fluid line diameters.

As shown in FIG. 1, in the conventional de-aeration cycle 10, the coolant in the de-aeration line 20 first passes through an in-line filter 24 and then is output as filtered coolant from the filter 24. In this configuration, only the coolant passing through the de-aeration line 20 passes through the filter 24 (i.e., is filtered) to remove potential impurities, while the remaining coolant in the bypass line 18 completely bypasses the filter 24 along with a de-aeration reservoir 26 (i.e., reservoir). The filtered coolant flows downstream from the filter 24 and is fed to the reservoir 26, described below. The reservoir 26 de-aerates the filtered coolant and outputs a de-aerated coolant, which is then combined with the coolant from the bypass line 18 to provide partially de-aerated coolant, which is then fed back to the component 12. The cycle then repeats, such that a portion of the coolant is filtered and de-aerated with each pass through the cycle. In the long run, substantially all of the coolant is filtered, but it takes several complete cycles before all of the coolant is filtered. For example, if only 20% of the coolant passes through the filter in any given cycle, then the coolant will have to pass through the reservoir 26 at least five times before all of the coolant is filtered, limiting the overall filtering efficiency of the reservoir 26.

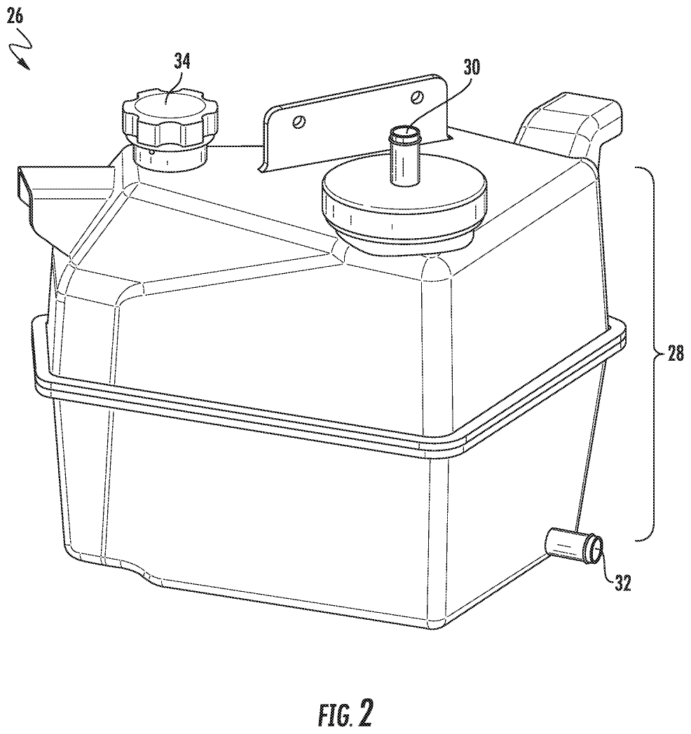

Referring now to FIG. 2, a reservoir 26 used in a conventional process as described above with respect to FIG. 1 is shown. The reservoir 26 includes a shell 28 having an inlet 30 at an upstream portion of the reservoir 26 that is configured to receive coolant, and an outlet 32 at a downstream portion of the reservoir 26 that is configured to output coolant for recirculation in the cycle 10. As discussed above, the filter 24 is disposed in the cycle 10 upstream from the inlet 30 and external to the reservoir 26. The reservoir 26 may further include a pressure relief cap 34, which allows air or other gas to be selectively released from the reservoir if the pressure within the reservoir 26 or the cycle 10 exceeds a pre-determined threshold pressure. It should further be understood that the cycle 10 is a pressurized (i.e., closed) system, such that no air or other gas is introduced to or is output from the cycle 10 during operation and once the cycle 10 is fully operational, it reaches steady pressure. During the first operation of the cycle 10 after the reservoir 26 has been filled the cap 34 releases pressure until the reservoir 26 reaches its threshold operating pressure and during long-term operation, no additional pressure is released through the cap 34. As shown in FIG. 2, the cap 34 is located in the shell 28 separate from the inlet 30, such that multiple openings must he formed in the shell 28 for coolant inflow as well as pressure control, adding to the manufacturing costs for the reservoir 26.

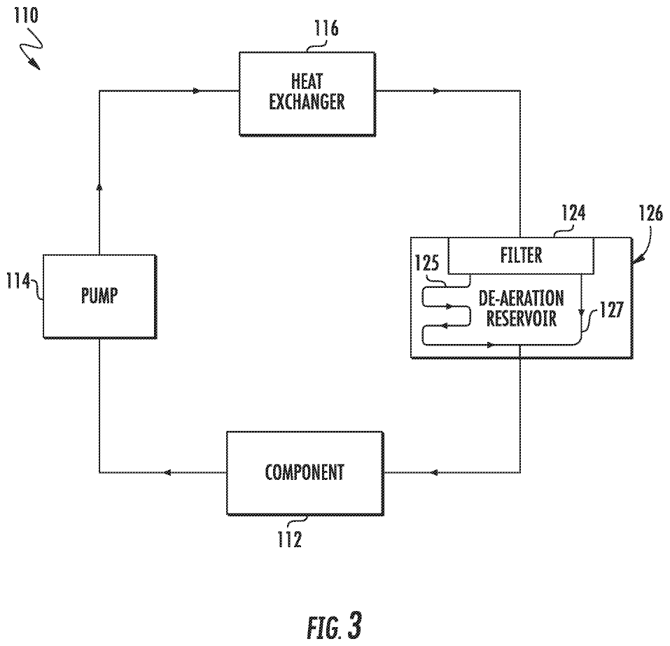

Referring now to FIG. 3, an improved de-aeration cycle 110 for a vehicle is shown according to an exemplary embodiment. The vehicle includes a component 112 in a vehicle system, such as an HVAC system, a battery cooling system, or an engine cooling system. Coolant passes through the component 112 and heat is transferred from the component 112 to the coolant, such that the temperature in the coolant increases while the temperature in the component 112 decreases. It should further be understood that according to other exemplary embodiments, the coolant or other fluid may be heated prior to being fed to the component 112 to transfer heat to the component 112, such that the temperature of the coolant decreases while the temperature of the component 112 increases. For ease of description, however, the following discussion will assume that heat is transferred from the component to the coolant.

In the de-aeration cycle 110, coolant flows from the component 112 to a pump 114. The pump 114 then outputs the coolant to a heat exchanger 116, in which heat is transferred out of the coolant, dropping the temperature of the coolant before being reintroduced to the component 112. The heat exchanger 116 may be an evaporator, a condenser, or another type of device that is configured to draw heat away from the coolant, thereby decreasing the temperature of the coolant. The heat exchanger 116 then outputs cooled coolant to a reservoir 126 (i.e., a de-gassing bottle).

A filter 124 is disposed within the reservoir 126, and the coolant received by the reservoir 126 first passes through the filter 124 before being de-aerated and output to the component 112. In this configuration, substantially all of the coolant passes through the filter 124 to remove any impurities in the coolant prior to the coolant being de-aerated. This configuration is in contrast to the conventional de-aeration cycle 10 in FIG. 1, in which only a portion of the coolant passed through the filter 24 at a time, allowing impurities to remain in the system much longer.

FIG. 3 shows the pump 114 located directly downstream from the component 112, the heat exchanger 116 directly downstream from the pump 114, the reservoir 120 directly downstream from the heat exchanger 116, and the component 112 directly downstream from the reservoir 126. According to other exemplary embodiments, the cycle 110 may be arranged in other orders. While FIG. 3 shows the filter 124 at an upstream end of the reservoir 126, according to other exemplary embodiments, the filter 124 may be disposed in the reservoir 126 at a downstream end or other portion thereof. According to yet another exemplary embodiment, the filter 124 may be disposed external to and upstream from the reservoir 126, such that the filter 124 is in-line (e.g., in series) with the reservoir 126 and all of the coolant in the cycle 110 passes through the filter 124 before being received in the reservoir 126 and divided into a de-aeration portion 125, which remains in the reservoir 126 for de-aeration and a bypass portion 127, which bypasses the de-aeration process and is immediately output from the reservoir 126 and recirculated back into the cycle 110.

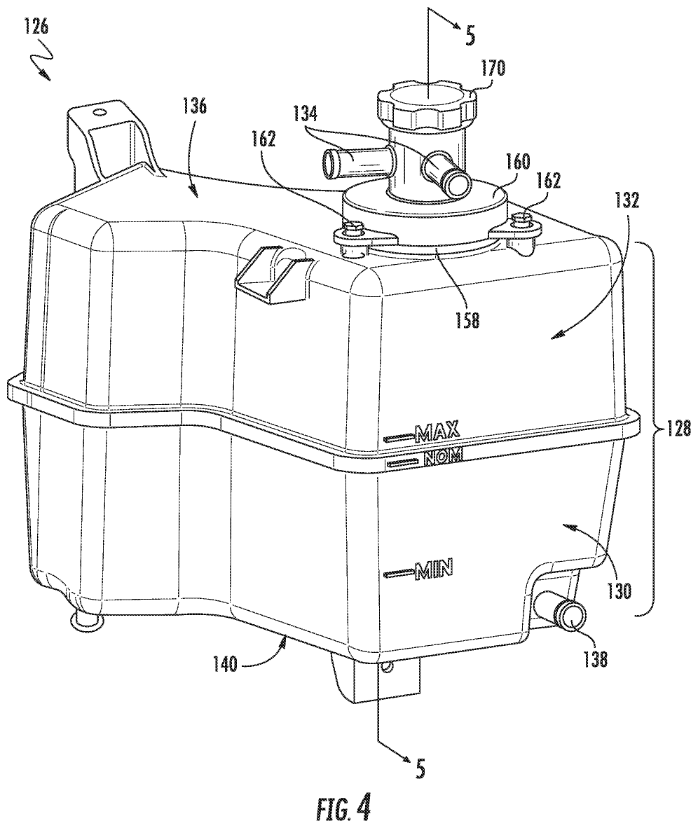

Referring now to FIG. 4, the reservoir 126 is shown according to an exemplary embodiment. The reservoir 126 includes a shell 128 configured to receive and de-aerate coolant in a vehicle. As shown in FIG. 4, the shell 128 may include a lower (i.e., first) body 130 and an upper (i.e., second) body 132 disposed on the lower body 130. The upper body 132 sealingly engages the lower body 130, such that the shell 128 is sealed and configured to be pressurized to a pre-determined threshold pressure.

The reservoir 126 includes at least one inlet 134 (i.e., inlet connector) configured to receive coolant in the reservoir 126 for de-aeration. The inlet 134 may be disposed at or above an upper surface 136 of the shell 128 (e.g., of the upper body 132), such that the coolant flows generally downward through at least a portion of the shell 128. As shown in FIG. 4, the reservoir 126 includes two inlets 134, although according to other exemplary embodiments, the reservoir 126 may include a greater or lesser number of inlets. The reservoir 126 further includes at least one outlet 138 (i.e., outlet connector) configured to output de-aerated coolant for reintroduction to the cycle 110. The outlet 138 may be disposed at, proximate, or below a lower surface 140 of the shell 128 (e.g., of the lower body 130). Specifically, if the outlet 138 is disposed higher within the shell 128, the output of coolant from the shell 128 upstream from the lower surface 140 may limit the complete circulation and mixing of coolant in the reservoir 126, as coolant received at the inlet 134 passes more directly to the outlet 138, allowing the coolant below the outlet 138 to stagnate and de-aerate more than the coolant continuously flowing through the reservoir 126. In the configuration shown in FIG. 4, the outlet 138 is at a most downstream end of the reservoir 126, which ensures complete and efficient mixing of all of the coolant in the reservoir 126, such that the coolant output is de-aerated to a substantially homogeneous consistency.

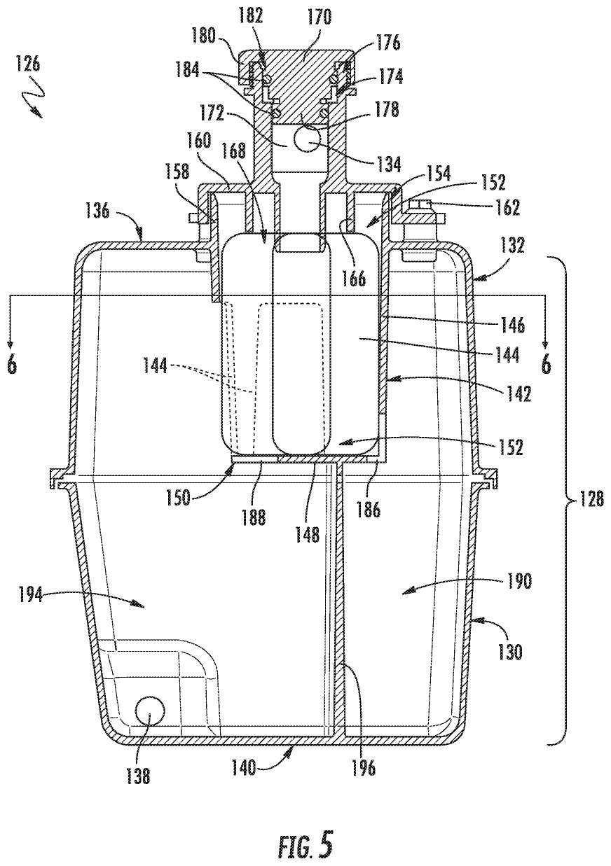

Referring now to FIG. 5, a cross-sectional view of the reservoir 126 is shown according to an exemplary embodiment. The reservoir 126 includes a receptacle 142 (i.e., a housing, canister, cup, receiver, etc.) formed by the shell 128 and extending into an interior of the shell 128, downstream from the inlet 134. A filter 144 is disposed in the receptacle 142, such that the filter 144 is also downstream from inlet 134. In this configuration, substantially all of the coolant passes through the filter 144, providing more certainty that impurities are removed from the coolant, regardless of whether that portion of the coolant is being de-aerated during any particular pass through the reservoir 126.

The receptacle 142 is substantially cylindrical or any other suitable shape complementary to and configured to receive the filter 144. As shown in FIG. 5, the receptacle 142 includes one or more side walls 146, extending substantially vertically downward from the upper surface 136 toward the lower surface 140 of the shell 128. The receptacle 142 further includes a lower wall 148 (i.e., member, base, strut, support, brace, surface, etc.) formed at a lower end 150 of the receptacle 142 (e.g., at a lower end of the one or more side walls 146). A lower end 152 of the filter 144 is disposed on the lower wall 148, such that the lower wall 148 supports the weight of the filter 144, holding the filter 144 in position in the receptacle 142 and preventing the filter 144 from passing further into the shell 128.

An upper end 154 of the receptacle 142 defines a receptacle opening 156 configured to receive the filter 144. For example, when the filter 144 is first inserted or replaced in the reservoir after it has been used, the filter 144 is fed downward through the receptacle opening 156 toward the lower end 150 of the receptacle 142 until the filter 144 comes into contact with the lower wall 148 of the receptacle 142. As shown in FIG. 5, the upper end 154 of the receptacle 142 extends upward (e,g., outward) away from the upper surface 136 of the shell 128, such that the one or more side walls 146 defines a lip 158 extending from the upper surface 136. While FIG. 5 shows the lip 158 raised above the upper surface 136 of the shell 128, according to other exemplary embodiments, the upper end 154 of the receptacle 142 may be co-planar with the upper surface 136 or other surfaces of the shell 128.

Referring to FIGS. 4 and 5, the reservoir 126 further includes a cover 160 disposed on and sealingly engaging the upper end 154 of the receptacle 142, such that the cover 160 encloses the receptacle opening 156. The cover 160 may be coupled to the shell 128 with one or more (e.g., a plurality of) fasteners 162 (e.g., bolt, screw, etc.) or may be removably coupled to the shell 128 in other ways. As shown in FIGS. 4 and 5, the cover 160 is coupled to the upper surface 136 of the shell 128 external to and proximate (e.g., annularly about) the lip 158 at the upper end 154 of the receptacle 142. According to another exemplary embodiment, the cover 160 may be threadably coupled to the lip 158 or other portion of the shell 128. Referring to FIG. 5, when the cover 160 is in place on the receptacle 142, the cover 160 is disposed over (i.e., above) the filter 144, preventing the filter 144 from being removed from the receptacle 142. For example, a securing member 166 or other portion of the cover 160 may extend downward into the receptacle 142, such that it is disposed proximate or engages an upper end 168 of the filter 144. In this configuration, the cover 160 holds the filter in a stationary vertical position in the reservoir 126, even as external forces are applied on the reservoir 126 due to the vehicle's movement.

Referring again to FIGS. 4 and 5, the reservoir 126 includes a cap 170 disposed on the cover 160. The cover 160 defines a passage 172 (i.e., conduit) extending therethrough and the inlets 134 are fluidly connected to the passage 172. The passage 172 extends downward in the cover 160 toward the filter 144, such that coolant is passed from the inlets 134, through the passage 172 and to the filter 144. The passage 172 further extends upward through the cover 160 toward a cover opening 174 at an upper end 176 of the cover 160. In this configuration, when the cap 170 is removed (i.e., decoupled) from the cover 160, the interior of the reservoir 126 is accessible. For example, if the level of coolant in the reservoir 126 is too low to operate properly (e.g., below a threshold volume), the reservoir 126 may be filled by supplying additional coolant through the passage 172. Notably, the passage 172, including the cover opening 174, is formed upstream from the filter 144, such that coolant is filtered before it ever enters circulation in the cycle 110 generally or in the reservoir 126 more specifically.

The cap 170 includes a neck 178 (e.g., a cap body) and a shoulder 180 (e.g., outer flange, collar, etc.) disposed annularly about the neck 178 and spaced apart from the neck 178, forming a channel 182 (i.e., a cap channel) therebetween. A portion of the cap 170 (e.g., the neck 178) is configured to be received through the cover opening 174, until the neck 178 is disposed proximate and/or engages the passage 172. The neck 178 includes at least one gasket 184 (e.g., a plurality of gaskets) disposed annularly about the neck 178 and configured to be compressed between the neck 178 and the passage 172, such that the cap 170 sealingly engages the cover 160. FIG. 5 shows the cap 170 having two gaskets 184, although according to other exemplary embodiments, more or fewer gaskets 184 may be used. According to yet another exemplary embodiment, the gaskets 184 may be disposed in the passage 172, such that the neck 178 of the cap 170 engages the gaskets 184 when it is inserted into the passage 172. The gaskets 184 may be configured to compress, allowing air to pass between the cap 170 and the passage 172 when a pressure in the reservoir 126 exceeds a threshold pressure. In this configuration, the cap 170 serves as a pressure-relief mechanism, preventing a pressure buildup in the reservoir 126 as air is released from the coolant and the coolant heats up.

When the cap 170 is fully installed on the cover 160, the cap 170 may be threadably coupled to the cover 160. For example, an inner surface of the shoulder 180, which forms one side of the channel 182, may be threaded (e.g., internally threaded) and an opposing corresponding outer surface at the upper end 176 of the cover 160 may also be threaded (e.g., externally threaded), such that the channel 182 is configured to threadably engage the cover 160. According to another exemplary embodiment, an outer surface of the neck 178, which forms another side of the channel 182 may be threaded (e.g., externally threaded) and an opposing corresponding inner surface of the passage 172 at the cover opening 174 may also be threaded (e.g., internally threaded), such that the channel 182 is configured to threadably engage the cover 160.

Referring still to FIG. 5, the receptacle 142 defines (e.g., includes) a de-aeration (i.e., first) opening 186 and a bypass (i.e., second) opening 188. The de-aeration opening 186 and the bypass opening 188 are each formed in one or both of the side walls 146 and/or the lower wall 148 of the receptacle 142. Specifically, the de-aeration opening 186 and bypass opening 188 are formed proximate the lower end 150 of the receptacle 142, such that coolant passing through the filter 144 does not stagnate at the lower end 150 of the receptacle and substantially all of the coolant entering the filter 144 is output into the reservoir 126 through either the de-aeration opening 186 or the bypass opening 188.

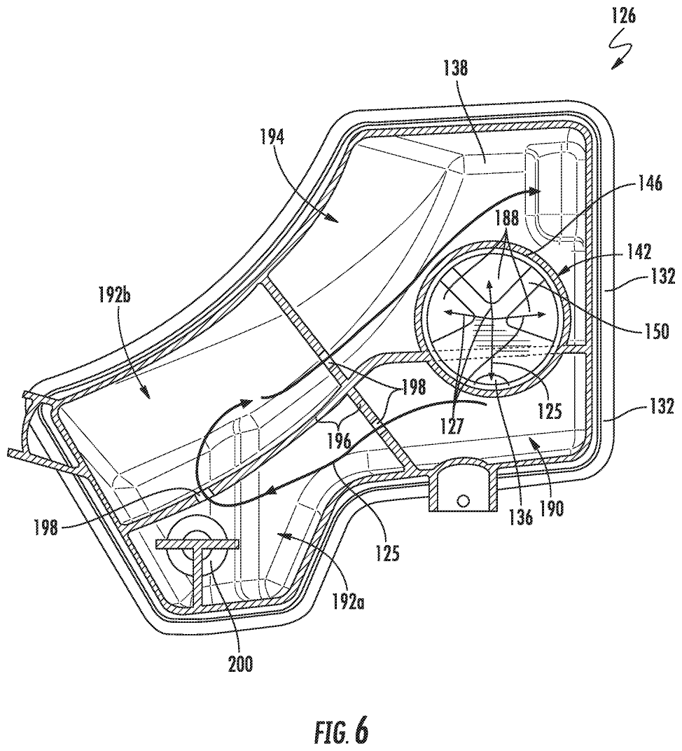

Referring now to FIG. 6, a cross-sectional view of the reservoir 126 taken across line 6-6 in FIG. 5 is shown with the receptacle 142 according to an exemplary embodiment. Notably, the bypass opening 188 includes a plurality of openings extending through the lower wall 150 and/or the side walls 148 of the receptacle 142. Specifically, FIG. 6 shows the bypass opening 188 with three openings, although more or fewer openings may be included. Portions of the lower wall 150 separate each of the bypass openings 188 and provide a support for the filter 144 to rest on, even though the majority of the surface area of the lower wall 150 is removed. FIG. 6 shows the de-aeration opening 186 (shown as a small semi-circular opening in the lower wall 150) configured as a single opening separated from the bypass openings 188 with portions of the lower wall 150, although it should be understood that the de-aeration opening 186 may also include a plurality of openings.

Referring to FIGS. 5 and 6, the reservoir 126 includes a plurality of chambers (i.e., compartments) defined therein. Specifically the reservoir 126 includes an inlet (i.e., first) chamber 190 disposed directly downstream from the de-aeration opening 186. The reservoir 126 further includes one or more intermediate chambers 192 disposed downstream from the inlet chamber 190. For example, FIG. 6 shows the reservoir 126 having two intermediate (i.e., second and third) chambers 192, including a first intermediate chamber 192a downstream from the inlet chamber 190 and a second intermediate chamber 192b downstream from the first intermediate chamber 192a, although according to other exemplary embodiments, the reservoir 126 may include a greater or lesser number of intermediate chambers 192 or may not include any intermediate chambers 192. The reservoir 126 further includes an outlet (i.e., fourth) chamber 194 downstream from the inlet chamber 190 and the intermediate chambers 192. The outlet chamber 194 is the chamber furthest downstream in the reservoir 126 and the outlet 138 extends from the outlet chamber 194 and is configured to output coolant therefrom.

The reservoir 126 is subdivided by a plurality of chamber walls 196 extending vertically in the reservoir 126. Each of the chamber walls may extend from the lower surface 140 of the shell 128 upward toward the upper surface 136 until they contact the upper surface 136 or another surface. For example, as shown in FIG. 5, the chamber wall 196 extends upward from the lower surface 140 until it reaches the lower wall 150 of the receptacle 142. According to an exemplary embodiment, each of the chamber walls 196 may be subdivided into at least two portions, such that a first portion forms a part of the lower body 130 of the shell 128 and the second portion forms a part of the upper body 132. In this configuration, the lower and upper parts may be substantially aligned, such that the chamber walls 196 subdivide the chambers at all coolant levels in the reservoir 126, fluidly separating non-adjacent chambers. At least one chamber opening 198 is defined in (e.g., extends through) each chamber wall 196 between adjacent chambers, allowing coolant to pass downstream from the inlet chamber 190, the first and second intermediate chambers 192a, 192b, and the outlet chamber 194, until the coolant is output from the reservoir 126 through the outlet 138.

As discussed above, as the coolant passes downstream through the chambers 190, 192, 194, the coolant slows down and/or is stationary at various times. The lack of movement of the coolant causes the air pockets in the coolant to start to collapse due to not being disturbed and therefore the contents of the reservoir 126 becomes generally more de-aerated the longer it takes to pass to and be output from the outlet 138. It should be understood that the longer the coolant flows through the reservoir 126, the more the coolant de-aerates. As a result, the reservoir 126 may further de-aerate the coolant by adding more.

Referring again to FIG. 6, the receptacle 140 is shown having a plurality of bypass openings 188. The bypass openings 188 are formed in the portion of the receptacle 142 that is aligned with the outlet chamber 194, such that the outlet chamber 194 is directly downstream from the receptacle 142 and coolant flows from the filter 144, directly through the bypass openings 188 into the outlet chamber 194 and out of the reservoir 126 through the outlet 138. While FIG. 6 shows the outlet chamber 194 directly downstream from the receptacle 142 through the bypass openings 188, according to other exemplary embodiments, the bypass openings 188 may be aligned with other chambers (e.g., the intermediate chambers 190). As shown in FIG. 6, the chamber wall 196 further extends from the lower wall 150 of the receptacle 142, fluidly separating, directly downstream from the receptacle 142, coolant passing through the de-aeration opening 186 from coolant passing through the bypass openings 188.

The volume flow rate through the de-aeration opening 186 and the bypass opening 188 may be determined based on and directly related to the relative areas of each of the de-aeration opening 186 and the bypass openings 188. For example, the de-aeration opening 186 may define a de-aeration area A_{D} and the bypass openings 188 may define a cumulative bypass area A_{B} greater than the de-aeration area A_{D}. The receptacle 142 may have a ratio of bypass area A_{B} to de-aeration area A_{D} of approximately 9:1, such that approximately 90% of the coolant (e.g., the bypass portion 127) passes through the bypass openings 188 directly into the outlet chamber 194, while the remaining 10% of the coolant (e.g., the de-aeration portion 125) initially received in the receptacle 142 passes through the de-aeration opening 186. The coolant passed through the de-aeration opening 186 then flows downstream through the inlet chamber 190 and the intermediate chambers 192 until it is passed into the outlet chamber 194 where it is mixed with the coolant that bypassed the de-aeration cycle. According to other exemplary embodiments, the area ratio A_{B}:A_{D} may have other values, such that between approximately 75% and 95% of the coolant passes through the bypass openings 188 and the remaining 5% to 25% passes through the de-aeration opening 186. For example an area ratio A_{B}:A_{D} of 4:1 indicates that approximately 80% of the coolant passes through the bypass openings 188 and the remaining approximately 20% of the coolant passes through the de-aeration opening 186.

Referring still to FIG. 6, the reservoir 126 includes a coolant sensor 200 configured to measure (i.e. sense) an amount of coolant in the reservoir 126 by determining a height of the coolant above the lower surface 140 of the shell 128. If the height falls below a threshold value, the sensor 200 sends a signal to a display in the vehicle indicating that the volume of coolant is low and that additional coolant should be added to the reservoir 126 (e.g., through the passage 172.

As illustrated herein, an improved de-aeration system allows for filtering of all coolant entering the de-aeration reservoir, and subsequent to such filtering, the coolant may be divided into a de-aeration stream and a bypass stream. In this manner, although only a portion of the coolant is de-aerated on any given pass through the de-aeration reservoir, all of the coolant will be filtered. In this manner, impurities that may be present in the coolant may be filtered out sooner than they would in conventional systems.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, values of parameters, mounting arrangements, orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A de-aeration reservoir for a vehicle comprising:
an inlet and an outlet;
a receptacle configured to receive a filter therein, the receptacle located downstream from the inlet;
a plurality of chambers in the reservoir located downstream from the receptacle; and
a de-aeration opening formed in the receptacle and fluidly connecting the receptacle to an inlet chamber of the plurality of chambers.

2. The de-aeration reservoir of claim 1, further comprising at least one bypass opening formed in the receptacle and fluidly connecting the receptacle to an outlet chamber of the plurality of chambers;
wherein the outlet chamber is downstream from the inlet chamber.

3. The de-aeration reservoir of claim 2, wherein:
the at least one bypass opening defines a bypass area;
the de-aeration opening defines a de-aeration area; and
the bypass area is greater than the de-aeration area.

4. The de-aeration reservoir of claim 3, wherein a ratio of the bypass area to the de-aeration area is approximately 9:1.

5. The de-aeration reservoir of claim 2, wherein:
the receptacle defines a side wall and a lower wall;
the at least one bypass opening and the de-aeration opening extend through the lower wall; and
the lower wall is configured to support a filter disposed in the receptacle.

6. The de-aeration reservoir of claim 5, wherein the at least one bypass opening extends through the side wall of the receptacle.

7. The de-aeration reservoir of claim 2, further comprising a chamber wall disposed between the inlet chamber and the outlet chamber;
wherein the chamber wall extends from the lower wall of the receptacle and fluidly separates coolant passing downstream through the bypass opening from cooling passing downstream through the de-aeration opening.

8. The de-aeration reservoir of claim 2, wherein the plurality of chambers further comprises at least one intermediate chamber disposed between the inlet chamber and the outlet chamber.

9. The de-aeration reservoir of claim 8, wherein at least one intermediate chamber comprises a plurality of intermediate chambers.

10. The de-aeration reservoir of claim 8, wherein:
the plurality of chambers are formed by chamber walls extending vertically in the reservoir; and
adjacent chambers in the plurality of chambers are fluidly connected with chamber openings defined in each chamber wall.

11. The de-aeration reservoir of claim 1, further comprising a cover disposed on and sealingly engaging an upper end of the receptacle.

12. The de-aeration reservoir of claim 6, wherein the inlet is connected to the cover.

13. The de-aeration reservoir of claim 6, wherein the cover defines a passage extending therethrough; and
further comprising a cap received in the passage and removably coupled to the cover.

14. A method of de-aerating coolant in a vehicle comprising:
receiving coolant at an inlet of a reservoir, the reservoir defining a receptacle and a filter disposed in the receptacle; and
passing the coolant downstream from the inlet to the filter.

15. The method of claim 14, wherein substantially all of the coolant received at the inlet is passed through the filter.

16. The method of claim 14, further comprising:
outputting a de-aeration portion of the coolant from the filter, through a de-aeration opening in the receptacle, and into an inlet chamber; and
outputting a bypass portion of the coolant form the filter, through a bypass opening in the receptacle, and into an outlet chamber downstream from the inlet chamber.

17. The method of claim 16, wherein the bypass portion of the coolant is greater than the de-aeration portion of the coolant.

18. The method of claim 16, further comprising:
passing the de-aeration portion of the coolant through at least one intermediate chamber disposed between in the inlet chamber and the outlet chamber; and
de-aerating the de-aeration portion of the coolant in the at least one intermediate chamber.

19. The method of claim 17, further comprising:
passing the de-aeration portion of the coolant from the at least one intermediate chamber to the outlet chamber; and
mixing the de-aeration portion and the bypass portion of the coolant in the outlet chamber.

20. The method of claim 14, further comprising adding coolant to the reservoir upstream from the filter.
